(19) United States
(12) Patent Application Publication
(10) Pub. No.: US 2019/0294669 A1
(43) Pub. Date: Sep. 26, 2019

(54) Smart Narrative Consumption Platform

(71) Applicant: Microsoft Technology Licensing, LLC, Redmond, WA (US)

(72) Inventor: Charan Kumbakonam MOHAN, Hyderabad (IN)

(73) Assignee: Microsoft Technology Licensing, LLC, Redmond, WA (US)

(21) Appl. No.: 15/925,899

(22) Filed: Mar. 20, 2018

(51) Int. Cl. G06F 17/27; G06F 17/30; G06N 7/00

(52) U.S. Cl. CPC G06F 17/2785; G06N 7/005; G06F 17/30979

(57) ABSTRACT

Described herein is a system and method for providing a summary of a portion of a narrative source document. Vectors for each of a plurality of attributes (e.g., characters, events, time, a sequence of events in chronology, characters and events in chronology, or events and characters in chronology, etc.) can be built based at least on a received portion of a narrative source document. A query can be received and an intent of the received query can be determined (e.g., using natural language processing). Summaries can be generated and probabilities calculated for each of the generated summaries using an algorithm applying a model, the vectors and the determined intent of the query. One or more of the generated summaries can be provided in response to the received query in accordance with the calculated probabilities.

### BACKGROUND

Text content consumption has evolved into myriad of ways starting with newspapers, books to computers, tablets, mobiles and hybrid devices such e-readers. Whether because of life events or personal preference, often users read a source document (e.g., book) for a certain period of days and subsequently are preoccupied with other activities.

### SUMMARY

Described herein is a system for providing a summary of a portion of a narrative source document, comprising: a computer comprising a processor and a memory having computer-executable instructions stored thereupon which, when executed by the processor, cause the computer to: build vectors for each of a plurality of attributes based at least on a received portion of a narrative source document; receive a query; determine an intent of a received query; generate summaries and calculate probabilities for each of the generated summaries using an algorithm applying a model, the vectors and the determined intent of the query; and, provide one or more of the generated summaries in response to the received query in accordance with the calculated probabilities.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for providing a summary of a portion of a narrative source document.

FIG. 2 is a flow chart that illustrate a method relating to providing a summary of a portion of a narrative source document.

FIG. 3 is a flow chart that illustrate another method relating to providing a summary of a portion of a narrative source document.

FIG. 4 is a flow chart that illustrate another method relating to providing a summary of a portion of a narrative source document.

FIG. 5 is a functional block diagram that illustrates an exemplary computing system.

### DETAILED DESCRIPTION

Various technologies pertaining to a smart narrative consumption platform are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding a smart narrative consumption platform. What follows are one or more exemplary systems and methods.

Aspects of the subject disclosure pertain to the technical problem of providing a summary across one or more attributes (e.g., characters, events, time, a sequence of events in chronology, characters and events in chronology, or events and characters in chronology, etc.) of a narrative source document up to a specific location in the narrative source document. The technical features associated with addressing this problem involve building vectors for each of a plurality of attributes based at least on a received portion of a narrative source document; receiving a query; determining an intent of the received query; generating summaries and calculating probabilities for each of the generated summaries responsive to the query using an algorithm applying a model, the vectors and the determined intent of the query; and, providing one or more of the summaries in response to the received query in accordance with the calculated probabilities. Accordingly, aspects of these technical features exhibit technical effects of more increasing user efficiency by reducing use of processing time and/or computer resource(s) while consuming the narrative source document.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

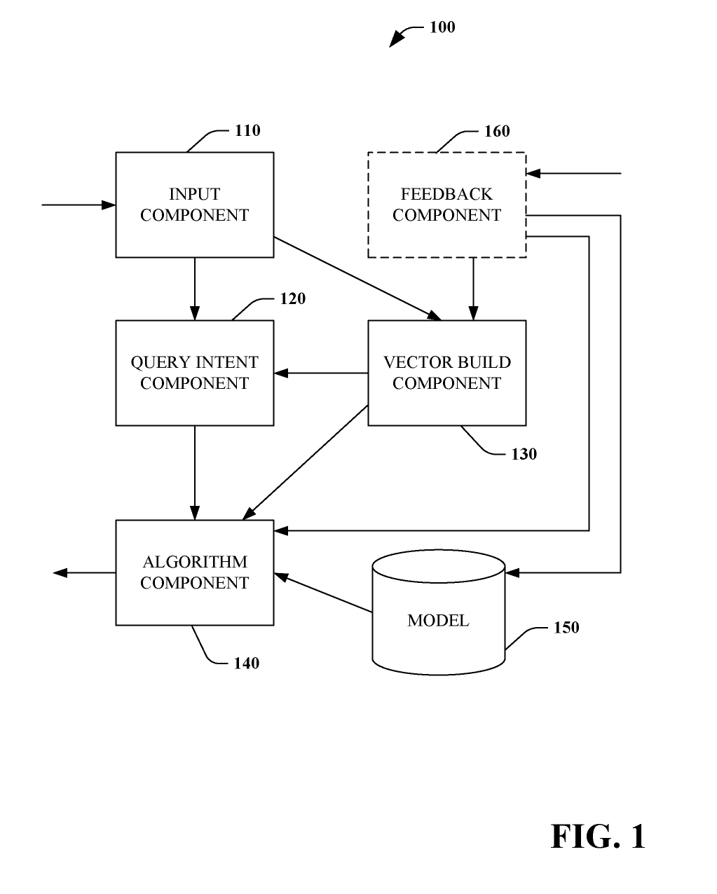

Referring to FIG. 1, a system for providing a summary of a portion of a narrative source document 100 is illustrated. For example, when a user returns to continue reading a narrative source document (e.g., book, story, paper, etc.), the user may be lost as to how an event occurred and/or how a character in a story is in a specific situation. Conventionally, the user could go back and skim through pages to understand the context and subsequently continue to read. Re-reading the portion of the narrative source documents the user has previously read or having a voice-based digital assistant (such a Cortana®) re-read the portion is not desirable as it is can be frustrating for the user and time-consuming. Additionally, in order to retain the reading experience, the user would generally not want to review a summary of the entire narrative source document, as the summary would likely include information that the user has not yet encountered in the user's reading of the narrative source document.

The system 100 can provide one or more summary(ies) to a user in response to a query regarding a portion of a narrative source document. In some embodiments, the summary(ies) are customized to the particular user, the particular query and the particular portion of the narrative source document.

In some embodiments, the system 100 is cloud-based and available to a user as a service. In some embodiments, the system 100 is resident on a user computer system. In some embodiments, portions of the system 100 are resident on the user computer system with other portions being available as a cloud-based service.

The system 100 includes an input component 110 that receives a query with respect to a portion of a narrative source document. The input component 110 provides the received query to a query intent component 120.

In some embodiments, the query is text-based, for example, received from a graphical user interface of a user's computer system, via a speech-to-text interface of the user's computer system, and/or via a digital assistant (e.g., Cortana®). In some embodiments, the query is voice-based, for example, received via a user interface of the user's computer system, and/or via a digital assistant.

In some embodiments, the input component 110 further receives a portion of the narrative source document. In some embodiments, the input component 110 receives a reference to the portion of the narrative source document. The reference can be a location within the portion of the narrative source document for example, a particular chapter, a particular page, a particular paragraph, a particular sentence, and/or a particular word located within the narrative source document. The vector component 120 can then obtain/access the portion of the narrative source document, for example, from a data store (not shown) based upon the received reference.

In some embodiments, the user can explicitly provide a location within the narrative source document up to which the user desires a summary relative to a particular query. For example, the user can locate a cursor to a particular location within the narrative source document, select (e.g., highlight) a particular chapter, page, a particular paragraph, a particular sentence, and/or a particular word located within the narrative source document etc. up to which the user desires a summary relative to a particular query.

In some embodiments, the location within the narrative source document is received implicitly. For example, the user can request a summary for a particular query up to the current location read within the narrative source document.

The input component 110 can provide the portion of narrative source document received and/or reference to location within the narrative source document to a vector component 130.

The vector component 130 can build vectors for each of a plurality of attributes based at least on the received portion of a narrative source document and/or reference to location within the narrative source document. In some embodiments, the attributes include character(s), event(s), and/or time. In some embodiments, the vector component 130 can create vectors that describe character(s), a sequence of events in chronology, characters and events in chronology, events and characters in chronology, and the like. In some embodiments, the vectors are built in response to receipt of the query using the portion of the narrative source document received. In some embodiments, building a vector for an attribute of “characters” includes determining context around a pronoun in order to disambiguate to which character the pronoun refers.

In some embodiments, the vectors are pre-built and available for use in responding to the query(ies). For example, particular narrative source documents (e.g., books) may be popular and the subject of frequent queries. In order to reduce response time and/or consumption of computing resources, the vector component 130 can build and store vectors for a plurality of locations (e.g., every chapter, every page, every paragraph, every sentence, etc.) within a particular narrative source document. Vectors corresponding to a particular location associated with a particular query are then available for use by the algorithm component 140 in responding to the particular query based at least on a received reference to the portion of the narrative source document.

The query intent component 120 can determine an intent of the query received from a user. In some embodiments, the query intent component 120 can determine query intent based on schema recognition, natural language processing, pattern recognition, machine learning, user feedback, etc. For example, the query intent component 120 can parse the received query and using natural language processing or similar methods, determine an intent of the query (e.g., character, event, and/or time based). In some embodiments, the query intent component 120 can utilize one or more vectors built by the vector component 130 in order to determine intent of the query. Natural language processing may be used to contextualize the query relative to the portion of the narrative source document (e.g., using the vectors). One or more user intents related to the query can be identified in order for the algorithm component 140 to generate relevant summary(ies) to the user.

In some embodiments, the query intent component 120 can process verbal and/or text data received from the user through one or more natural language processing engines such that relevant and irrelevant data can be filtered in or filtered out from further processing in order to identify contextual intent of the query. The query intent component 120 can additionally or alternatively determine, based on language-based processing of the data, that one or more keywords, phrases or language patterns are implicated and that the identified data should or should not be further processed and contextually utilized by query intent component 120.

In some embodiments, the query provided by the user can be a text-based query about the narrative source document. For example, for a narrative source document of the epic “The Ramayana”, the user can ask the query (e.g., text-based and/or audio) “Who is Sita and why is she imprisoned in Lanka”. In response to this query, the query intent component 120 can determine that the intent of the query relates to a character Sita, a location Lanka, and/or involves Sita's imprisonment.

An algorithm component 140 generates summaries and calculates probabilities for each of the generated summary using an algorithm applying a model 150, the vectors and the determined intent of the query, for example, in response to receiving the query. The summaries can be generated based upon high-ranking passages of the narrative source document based at least on the model, the vectors and the determined intent of the query.

In some embodiments, the model 150 employs one or more machine learning algorithms including linear regression algorithms, logistic regression algorithms, decision tree algorithms, support vector machine (SVM) algorithms, Naive Bayes algorithms, a K-nearest neighbors (KNN) algorithm, a K-means algorithm, a random forest algorithm, dimensionality reduction algorithms, and/or a Gradient Boost & Adaboost algorithm.

In some embodiments, the model 150 is trained (e.g., learned) using offline using vectors of attributes of particular portion(s) of particular narrative source document(s), particular determined intent(s) of query(ies) and actual (e.g., observed) summary(ies). Training can be performed in a supervised, unsupervised and/or semi-supervised manner. Summary(ies) generated and/or probabilities calculated by the algorithm can be compared with the actual (e.g., observed) with the algorithm adjusted accordingly.

In some embodiments, the model 150 can be trained based upon a set of particular portions(s) of particular narrative source documents, vectors of attributes of particular portion(s) of particular narrative source document(s), particular determined intent(s) of query(ies) and actual (e.g., observed) summary(ies). Training can be performed in a supervised, unsupervised and/or semi-supervised manner. Summary(ies) generated and/or probabilities calculated by the algorithm component 140 applying the model 150 can be compared with the actual (e.g., observed) with the model 150 adjusted accordingly. In some embodiments, the model 150 can be adaptively updated based upon user feedback, as discussed below.

In some embodiments, the summaries can include portions (e.g., paragraph(s), portion(s) of paragraph(s), sentence(s), and/or portion(s) of sentences) of the source narrative document considered important by the algorithm component 140. The algorithm component 140 can review context of the source narrative document and, as provided by the model, the vectors, and/or the determined intent of the query, when determining which portion(s) of the source narrative document to include in a particular summary. In some embodiments, the algorithm can be adapted based upon user feedback, as discussed below.

Continuing with the query regarding the narrative source document “The Ramayana” above, the algorithm component 140 can generate summaries (e.g., short descriptions) of passages of the narrative source documents related to a vector associated with characters (e.g., Sita), and a vector associated with events/character chronology (e.g., imprisonment on Lanka). The algorithm component 140 can generate a short description of the character derived based on context until that point in the narrative source document and provide a summary of how that the character got to this situation. As discussed below, in some embodiments, the summary generated by the algorithm component 140 can be refined using a rating and feedback model.

An algorithm component 140 can provide one or more of the summaries in response to the received query in accordance with the calculated probabilities. In some embodiments, a predetermined quantity of summaries are provided (e.g., three). In some embodiments, only summary(ies) with calculated probabilities (e.g., confidence factor) greater than a threshold probability are provided (e.g., greater than 90% probability). In some embodiments, which summary(ies) are provided is determined based upon a dynamically adjusted threshold, for example, based upon a history of a particular user (e.g., as stored in the model 150).

Optionally, the system 100 can include a feedback component 160 which can receive feedback information from the user in response to the provided generated summary(ies). In some embodiments, the feedback information can include a positive or negative indication regarding a particular summary. In some embodiments, the feedback information can include a scaled rating regarding particular summary(ies). The feedback component 160 can adapt the model 150, the vector component 130, and/or the query intent component 120 based upon the received feedback information.

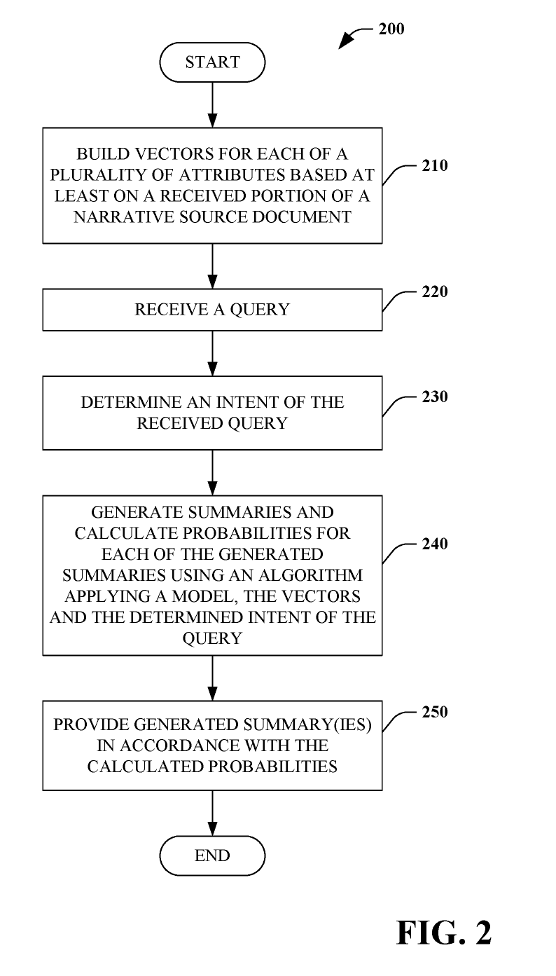

FIGS. 2-4 illustrate exemplary methodologies relating to providing a summary of a portion of a narrative source document. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 2, a method of providing a summary of a portion of a narrative source document 200. In some embodiments, the method 200 is performed by the system 100. At 210, vectors are built for each of a plurality of attributes based at least on a received portion of a narrative source document. At 220, a query is received. At 230, an intent of the received query is determined, for example, using natural language processing.

At 240, summaries are generated and probabilities are calculated for each of the generated summaries using an algorithm applying a model, the vectors and the determined intent of the query. At 250, the generated summary(ies) are provided in response to the received query in accordance with the calculated probabilities.

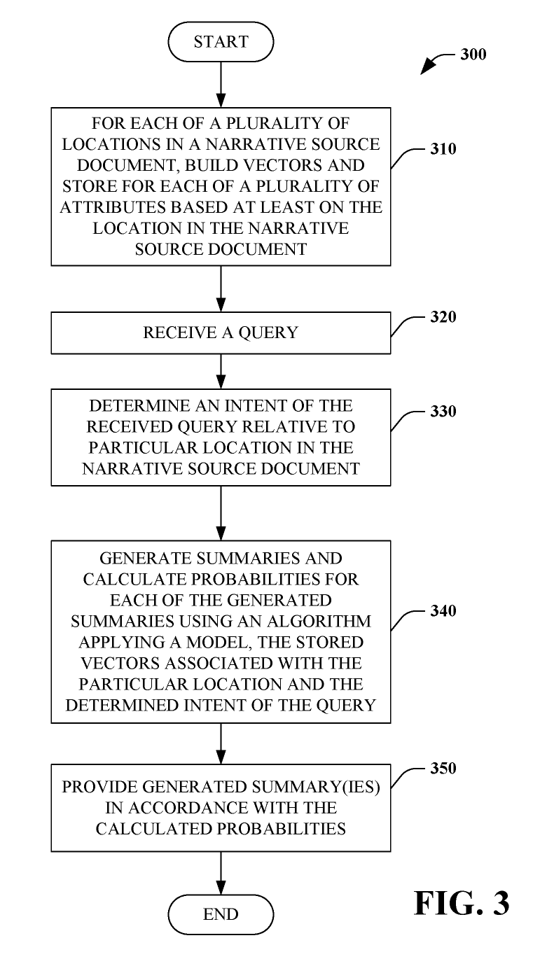

Turning to FIG. 3, a method of providing a summary of a portion of a narrative source document 300. In some embodiments, the method 300 is performed by the system 100. At 310, for each of a plurality of locations in a narrative source document, vectors are built and stored for each of a plurality of attributes based at least on the location in the narrative source document.

At 320, a query is received. At 330, intent of the received query relative to a particular location in the narrative source document is determined. At 340, summaries are generated and probabilities are calculated for each of the generated summaries using an algorithm applying a model, the stored vectors and the determined intent of the query (e.g., in response to receiving the query). At 350, the generated summary(ies) are provided in response to the received query in accordance with the calculated probabilities.

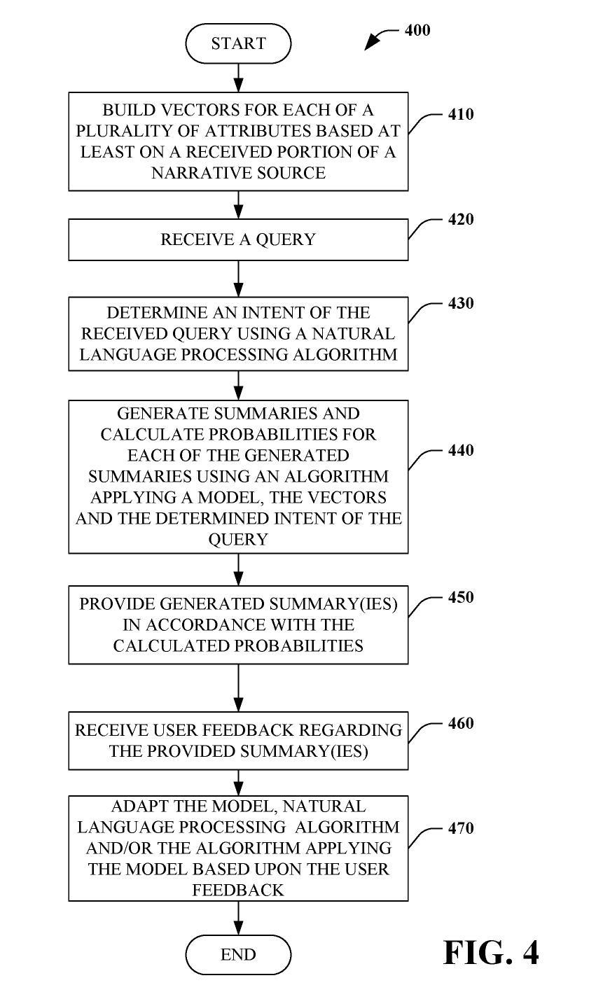

Referring to FIG. 4, a method of providing a summary of a portion of a narrative source document 400. In some embodiments, the method 400 is performed by the system 100. At 410, vectors are built for each of a plurality of attributes based at least on a received portion of a narrative source document. At 420, a query is received. At 430, an intent of the received query is determined using natural language processing algorithm.

At 440, summaries are generated and probabilities are calculated for each of the generated summaries using an algorithm applying a model, the vectors and the determined intent of the query. At 450, the generated summary(ies) are provided in response to the received query in accordance with the calculated probabilities.

At 460, user feedback regarding the provided summary(ies) is received. At 470, the model, the natural language processing algorithm and/or algorithm applying the model is adapted based upon the user feedback.

Described herein is a system for providing a summary of a portion of a narrative source document, comprising: a processing system comprising at least one processor and memory having computer-executable instructions stored thereupon which, when executed by the at least one processor, cause the processing system to: build vectors for each of a plurality of attributes based at least on a received portion of a narrative source document; receive a query; and based at least on receiving the query: determine an intent of the received query; generate summaries and calculate probabilities for each of the generated summaries using an algorithm applying a model, the vectors and the determined intent of the query; and provide one or more of the generated summaries in accordance with the calculated probabilities.

The system can further include wherein the intent of the received query is determined using natural language processing. The system can include wherein the plurality of attributes comprise at least one of a character, an event, or a time. The system can further include wherein the generated summaries are ranked hierarchically based upon the calculated probabilities.

The system can include wherein only generated summaries with calculated probabilities greater than a threshold probability are provided. The system can further include wherein one of the plurality of attributes is characters in the portion of the narrative source document and building a vector for the character attribute includes determining context around a pronoun in order to disambiguate to which character the pronoun refers. The system can include the memory having further computer-executable instructions stored thereupon which, when executed by the processor, cause the processing system to: receive user feedback regarding the provided one or more generated summaries; and adapt at least one of the model, a natural language processing algorithm used to determine intent of the query, or the algorithm applying the model based upon the user feedback.

The system can further include wherein the query is voice-based. The system can include wherein the vectors describe at least one of characters, a sequence of events in chronology, characters and events in chronology, or events and characters in chronology.

Described herein is a method of providing a summary of a portion of a narrative source document, comprising: building vectors for each of a plurality of attributes based at least upon a received portion of a narrative source document; receiving a query; based at least on receiving the query: determining an intent of the received query; generating summaries and calculating probabilities for each of the generated summaries using an algorithm applying a model, the vectors and the determined intent of the query; and providing one or more of the generated summaries in accordance with the calculated probabilities.

The method can further include wherein the intent of the received query is determined using natural language processing. The method can include wherein the vectors describe at least one of characters, a sequence of events in chronology, characters and events in chronology, or events and characters in chronology. The method can further include receiving user feedback regarding the provided one or more generated summaries; and adapting at least one of the model, a natural language processing algorithm used to determine intent of the query, or the algorithm applying the model based upon the user feedback.

The method can further include wherein the generated summaries are ranked hierarchically based upon the calculated probabilities. The method can include wherein only generated summaries with calculated probabilities greater than a threshold probability are provided. The method can further include wherein the plurality of attributes comprise at least one of a character, an event, or a time.

Described herein is a computer storage media storing computer-readable instructions that when executed cause a computing device to: build vectors for each of a plurality of attributes based upon a received portion of a narrative source document; receive a query; and based at least on receiving the query: determine an intent of the received query; generate summaries and calculate probabilities for each of the generated summaries using an algorithm applying a model, the vectors and the determined intent of the query; provide one or more of the generated summaries in response to the received query in accordance with the calculated probabilities; receive user feedback regarding the provided one or more generated summaries; and adapt at least one of the model, a natural language processing algorithm used to determine intent of the query, or the algorithm applying the model based upon the user feedback.

The computer storage media can further include wherein the vectors describe at least one of characters, a sequence of events in chronology, characters and events in chronology, or events and characters in chronology. The computer storage media can include wherein the generated summaries are ranked hierarchically based upon the calculated probabilities. The computer storage media can further include wherein only generated summaries with calculated probabilities greater than a threshold probability are provided.

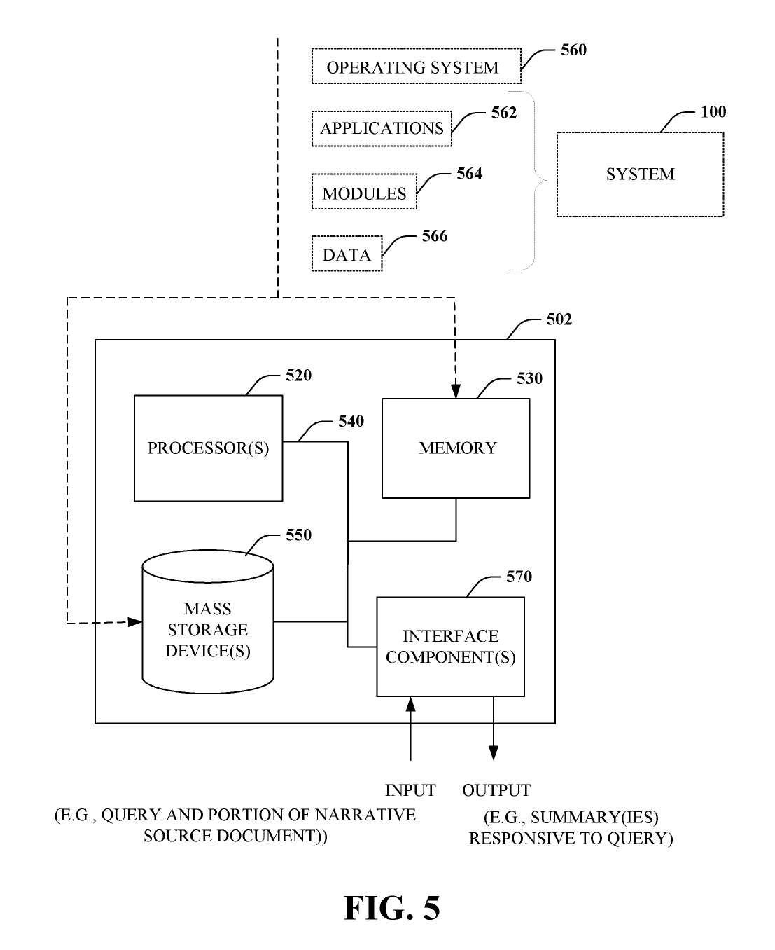

With reference to FIG. 5, illustrated is an example general-purpose processing system, computer, or computing device 502 (e.g., mobile phone, desktop, laptop, tablet, watch, server, hand-held, programmable consumer or industrial electronics, set-top box, game system, compute node, etc.). For instance, the computing device 502 may be used in a system for providing a summary of a portion of a narrative source document 100.

The computer 502 includes one or more processor(s) 520, memory 530, system bus 540, mass storage device(s) 550, and one or more interface components 570. The system bus 540 communicatively couples at least the above system constituents. However, it is to be appreciated that in its simplest form the computer 502 can include one or more processors 520 coupled to memory 530 that execute various computer executable actions, instructions, and or components stored in memory 530. The instructions may be, for instance, instructions for implementing functionality described as being carried out by one or more components discussed above or instructions for implementing one or more of the methods described above.

The processor(s) 520 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 520 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 520 can be a graphics processor.

The computer 502 can include or otherwise interact with a variety of computer-readable media to facilitate control of the computer 502 to implement one or more aspects of the claimed subject matter. The computer-readable media can be any available media that can be accessed by the computer 502 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 502. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 530 and mass storage device(s) 550 are examples of computer-readable storage media. Depending on the exact configuration and type of computing device, memory 530 may be volatile (e.g., RAM), non-volatile (e.g., ROM, flash memory, etc.) or some combination of the two. By way of example, the basic input/output system (BIOS), including basic routines to transfer information between elements within the computer 502, such as during start-up, can be stored in nonvolatile memory, while volatile memory can act as external cache memory to facilitate processing by the processor(s) 520, among other things.

Mass storage device(s) 550 includes removable/non-removable, volatile/non-volatile computer storage media for storage of large amounts of data relative to the memory 530. For example, mass storage device(s) 550 includes, but is not limited to, one or more devices such as a magnetic or optical disk drive, floppy disk drive, flash memory, solid-state drive, or memory stick.

Memory 530 and mass storage device(s) 550 can include, or have stored therein, operating system 560, one or more applications 562, one or more program modules 564, and data 566. The operating system 560 acts to control and allocate resources of the computer 502. Applications 562 include one or both of system and application software and can exploit management of resources by the operating system 560 through program modules 564 and data 566 stored in memory 530 and/or mass storage device (s) 550 to perform one or more actions. Accordingly, applications 562 can turn a general-purpose computer 502 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 562, and include one or more modules 564 and data 566 stored in memory and/or mass storage device(s) 550 whose functionality can be realized when executed by one or more processor(s) 520.

In accordance with one particular embodiment, the processor(s) 520 can correspond to a system on a chip (SOC) or like architecture including, or in other words integrating, both hardware and software on a single integrated circuit substrate. Here, the processor(s) 520 can include one or more processors as well as memory at least similar to processor(s) 520 and memory 530, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 502 also includes one or more interface components 570 that are communicatively coupled to the system bus 540 and facilitate interaction with the computer 502. By way of example, the interface component 570 can be a port (e.g., serial, parallel, PCMCIA, USB, FireWire, etc.) or an interface card (e.g., sound, video, etc.) or the like. In one example implementation, the interface component 570 can be embodied as a user input/output interface to enable a user to enter commands and information into the computer 502, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 570 can be embodied as an output peripheral interface to supply output to displays (e.g., LCD, LED, plasma, etc.), speakers, printers, and/or other computers, among other things. Still further yet, the interface component 570 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for providing a summary of a portion of a narrative source document, comprising:
a processing system comprising at least one processor and memory having computer-executable instructions stored thereupon which, when executed by the at least one processor, cause the processing system to:
build vectors for each of a plurality of attributes based at least on a received portion of a narrative source document;
receive a query; and
based at least on receiving the query:
determine an intent of the received query;
generate summaries and calculate probabilities for each of the generated summaries using an algorithm applying a model, the vectors and the determined intent of the query; and
provide one or more of the generated summaries in accordance with the calculated probabilities.

2. The system of claim 1, wherein the intent of the received query is determined using natural language processing.

3. The system of claim 1, wherein the plurality of attributes comprise at least one of a character, an event, or a time.

4. The system of claim 1, wherein the generated summaries are ranked hierarchically based upon the calculated probabilities.

5. The system of claim 4, wherein only generated summaries with calculated probabilities greater than a threshold probability are provided.

6. The system of claim 1, wherein one of the plurality of attributes is characters in the portion of the narrative source document and building a vector for the character attribute includes determining context around a pronoun in order to disambiguate to which character the pronoun refers.

7. The system of claim 1, the memory having further computer-executable instructions stored thereupon which, when executed by the processor, cause the processing system to:
receive user feedback regarding the provided one or more generated summaries; and
adapt at least one of the model, a natural language processing algorithm used to determine intent of the query, or the algorithm applying the model based upon the user feedback.

8. The system of claim 1, wherein the query is voice-based.

9. The system of claim 1, wherein the vectors describe at least one of characters, a sequence of events in chronology, characters and events in chronology, or events and characters in chronology.

10. A method of providing a summary of a portion of a narrative source document, comprising:
building vectors for each of a plurality of attributes based at least upon a received portion of a narrative source document;
receiving a query;
based at least on receiving the query:
determining an intent of the received query;
generating summaries and calculating probabilities for each of the generated summaries using an algorithm applying a model, the vectors and the determined intent of the query; and
providing one or more of the generated summaries in accordance with the calculated probabilities.

11. The method of claim 10, wherein the intent of the received query is determined using natural language processing.

12. The method of claim 10, wherein the vectors describe at least one of characters, a sequence of events in chronology, characters and events in chronology, or events and characters in chronology.

13. The method of claim 10, further comprising:
receiving user feedback regarding the provided one or more generated summaries; and
adapting at least one of the model, a natural language processing algorithm used to determine intent of the query, or the algorithm applying the model based upon the user feedback.

14. The method of claim 10, wherein the generated summaries are ranked hierarchically based upon the calculated probabilities.

15. The method of claim 14, wherein only generated summaries with calculated probabilities greater than a threshold probability are provided.

16. The method of claim 10, wherein the plurality of attributes comprise at least one of a character, an event, or a time.

17. A computer storage media storing computer-readable instructions that when executed cause a computing device to:
build vectors for each of a plurality of attributes based upon a received portion of a narrative source document;
receive a query; and
based at least on receiving the query:
determine an intent of the received query;
generate summaries and calculate probabilities for each of the generated summaries using an algorithm applying a model, the vectors and the determined intent of the query;
provide one or more of the generated summaries in response to the received query in accordance with the calculated probabilities;
receive user feedback regarding the provided one or more generated summaries; and
adapt at least one of the model, a natural language processing algorithm used to determine intent of the query, or the algorithm applying the model based upon the user feedback.

18. The computer storage media of claim 17, wherein the vectors describe at least one of characters, a sequence of events in chronology, characters and events in chronology, or events and characters in chronology.

19. The computer storage media of claim 17, wherein the generated summaries are ranked hierarchically based upon the calculated probabilities.

20. The computer storage media of claim 17, wherein only generated summaries with calculated probabilities greater than a threshold probability are provided.
